(19) United States
(12) Patent Application Publication
(10) Pub. No.: US 2019/0351445 A1
(43) Pub. Date: Nov. 21, 2019

(54) MATERIAL HANDLING RACK, SYSTEM AND METHOD

(71) Applicant: Edward Valpey, Gilford, NH (US)

(72) Inventor: Edward Valpey, Gilford, NH (US)

(21) Appl. No.: 15/981,389

(22) Filed: May 16, 2018

(51) Int. Cl. B05B 16/00; B65G 65/00

(52) U.S. Cl. CPC B05B 16/90; B65G 65/00

(57) ABSTRACT

A material handling rack, material handling system, powder coating system, and method utilizing the material handling system. The rack includes a series of tracks within which a series of movable track racks are disposed. In the material handling system, the tracks align with tracks of an adjacent rack to allow the track racks to be easily moved from one rack to another.

### FIELD OF THE INVENTION

The present invention relates generally to the field of material handling and, in particular, to racks and systems for processing a multitude of parts and subsequently transferring the processed parts for batch treatment.

### BACKGROUND OF THE INVENTION

The present invention was developed for use in the powder coating industry.

However, it is applicable to other industries, such as screen printing, paint spraying, or others, where a multitude of items or parts are processed in, and subsequently transferred from, a booth or other device or area where items or parts are processed individually, to an oven or other device or area where the items or parts are processed or treated as a batch.

Electrostatic powder coating is generally applied to parts in one of two ways. The simpler and more affordable method of powder coating is called the “batch” process. In a batch process, parts that have been cleaned and prepared are transferred from a rack, via a pole or sub-rack, into a spray booth, and then back to a rack. In some systems, the rack itself may be placed in the spray booth with the parts coated in place. However, this not preferred due to the tendency of powder oversprayed onto the racks to cure onto the racks and eventually render them unusable without the coating being removed. Regardless of whether the rack itself is placed in the booth, after the parts are powder coated they are manually transferred via the rack into an oven, where they are heated to a temperature that allows the powder coating to cure. The other primary process utilizes a “line” in which parts are hung from hooks on a conveyor line and travel through several stages, including cleaning, surface treatment, powder coating, curing and cooling, after which they are removed and packaged.

Powder coating lines allow greater efficiency than batch processes because they simultaneously process many parts at once in a system that is largely automated. While one part is being degreased another is being pre-treated and another is being coated, etc. Theoretically, a line with two operators can process hundreds of parts at a time. The batch process, on the other hand, requires manual input at every stage. Although powder coating lines are very efficient, they are also very expensive; purchase and installation costs typically exceed $100,000. Lines are also generally customized to a single part or group of parts and, therefore, the line process lacks the flexibility to process parts of different sizes. The batch process is less efficient, but is more affordable; basic equipment can be purchased for less than $15,000. Further, the batch process is extremely flexible and is easily adapted for use of parts of many different sizes. Accordingly, the batch process is favored in operations that process smaller numbers of varied parts while the line process has heretofore been favored in operations that process large numbers of similar parts.

The inventor of the present invention recognized that there is untapped potential in the batch process. Batch ovens generally have volumes that are comparable to ovens used in powder coating lines. However, the line process is unable to take full advantage of this volume because, with a constantly moving conveyor, there isn't time to load racks fully enough to optimize the oven's capacity. Further, in order to optimize the capacity of the oven, the parts would need to be racked in such a way that the individual applying the powder would not have access to the parts hidden behind other parts. Accordingly, lines would lose their efficiency in other stages if the line had to be stopped in order to allow the powder coater to manipulate racks of parts.

The conventional batch process is able to take full advantage of oven volume, but is likewise limited by the access of the powder coater. In order for a coater to powder parts on a rack, the parts must be accessible and therefore hung on the rack sparsely. If a rack is to be loaded densely, the coater must transfer the parts, pole by pole or sub-rack by sub-rack, from a rack filled with raw parts, to the booth, and then to a rack for coated parts. This is time-consuming and inefficient.

Therefore, there is a need for a system that allows parts to be packed densely on a rack while allowing them to be easily accessible to the person processing them, that does not require individual parts to be transferred from one rack or sub-rack to another after initial processing, that allows ovens or other batch processing areas or devices to be densely loaded without affecting the efficiency of other stages of the process, that does not require a large investment in equipment or installation costs, that combines the flexibility of the batch process with the efficiency of the line process.

### SUMMARY OF THE INVENTION

The present invention is a material handling rack, a material handling system, a powder coating system, and a method utilizing the material handling system that combines the advantages of line systems with those of batch systems.

The material handling system, which the inventor calls the “Track Rack” system, allows parts to be packed densely on a rack, but also allows them to be quickly removed from the rack in “sheets” that are easily accessible to the coater. The application time is comparable to that achieved by lines, but the number of parts baked at a given time is much greater. On balance, particularly for small to medium parts, the batch system becomes roughly as efficient as the line system. The system also allows the coating of larger parts that could not be coated on many line systems.

The Track Rack system utilizes two racks, each of which contain rows of tracks arrayed across the top section, or “ceiling”, of the rack. The first rack is referred to as the “booth rack” and the second rack, to which parts are transferred from the booth rack, is called the “oven rack”. The array of tracks on each rack is precisely aligned so that when the oven rack abuts the booth rack, slidable track bars onto which parts are attached may be transferred from the booth rack to the oven rack. This allows “sheets” of parts to be transferred from one rack to the other on individual tracks. The booth rack can be permanently affixed to a given location within a facility, or can be made modular so that it can be removed to allow greater access to the booth be transferred to other booths. The oven rack is preferably an adaptation of conventional batch process racks, which are designed to be moved from a preparation area to booth to oven. In some embodiments of the material handling system, the booth rack and oven rack are identical racks, which are interchangeable with one another.

The rack of the present invention includes a rack frame having a top section to which a plurality of tracks is disposed. The tracks are disposed in parallel relation to one another and are spaced in a predetermined manner such that the tracks of one rack will align with the tracks of another rack. In the preferred embodiment, the tracks are spaced by the use of a precision formed cross members, which align tracks and provide structural support for the tracks to allow them to be used in heavy duty applications. Each track is of substantially uniform cross section and includes a pair of open ends and an open slot through its bottom. The preferred tracks are formed sheet metal channels having flat portions along the bottom parallel to each side of the open slot. However, other tracks may be extruded or formed by other processes known in the art.

The rack also includes at least one track bar, and preferably includes one track bar for each track. The track bar is adapted to fit within the track such that a part racking portion thereof extends below the bottom of the track and such that it may be easily slid in and out of the open ends of the track. The part racking portion of the track bar is preferably a rectangular metal bar having a plurality of perforations therethrough to allow parts to be hung from hooks or sub-racks. The part racking portion is preferably sized to correspond with the size of the track but, in some embodiments, may be shorter or longer. The preferred track bar includes at least two, and preferably four, track casters attached to the top of the part racking portion of the track bar. The casters are dimensioned to fit within the track and are attached to the part racking portion such that the part racking portion is suspended below the bottom of the open slot in the track. The casters allow the track bar to be quickly and easily slid into and out of the open ends of the track.

The preferred rack includes a stop mechanism that allows the track bars to be locked into place, which prevents them from inadvertently sliding out of the tracks when the rack is moved. In the preferred embodiment, the stop mechanism is a track lock that creates a barricade at the open end of each track. The preferred track lock includes a locking tube that is pivoted upward and clears the ends of the tracks by a protrusion extending from an adjacent rack. When the adjacent rack is removed, the locking tube automatically falls back into place in front of the open ends of the tracks. In another embodiment, the stop mechanism is a toggle cam style mechanism, in which a pivoting toggle is manually rotated to engage a series of cams that extend through slots in each track and exert a downward force upon each track bar to maintain it in place.

The rack frame is preferably manufactured of metal and takes the form of an open sided rectangular parallelepiped having four side members four top members and four bottom members. In the preferred embodiment, four casters extend from the bottom four members of the rack frame to allow it to be easily moved from one location to another. However, these casters are omitted in other embodiments and, instead, the racks are moved by external means, such as carts or rails. In some embodiments of the rack in which it is used as a booth rack, the rack frame is made up only of a series of top members to which the tracks are disposed. In these embodiments, the top members preferably include flexible attachments, such as chains, cables or the like, that suspend the rack from a ceiling and allow it to be more easily aligned with an adjacent rack.

The preferred rack also includes a rack attachment system that allows one rack to be attached to another. The preferred rack attachment system is a toggle latch system in which toggle latches are mounted to each side of one rack and slide into mating latches on an adjacent rack. However, in other embodiments the rack attachment system may simply take the form of a pin or magnetic latch that affixes the racks in the desired position.

The preferred powder coating system includes a booth rack and at least one oven rack. In some embodiments, the system also includes an oven. The booth rack and the oven rack are sized to mate with one another, while the oven rack is dimensioned to fit within the oven. The booth rack may take any of the forms described above while the oven rack must be a movable rack that can be moved into and out of the oven.

The method of the present invention includes the following steps. Aligning two racks together such that the tracks of one rack correspond with the tracks of another. Processing parts mounted to a first track bar disposed in the first track of a first rack, and sliding the first track bar from the first rack to the second rack. Processing parts mounted to a second track bar disposed in the second track of a first rack, and sliding the second track bar from the first rack to the second rack. Continuing to process parts mounted to track bars disposed in the track of the first rack, and sliding the track bars from the first rack to the second rack until the second rack is full. Moving the second rack into a batch processing station for batch processing, and removing the second rack from the processing station after the parts have been processed.

The Track Rack System provides a number of advantages, including:

1) Reduced Booth Time and Coater Fatigue: As currently processed, if a rack is to be densely populated with parts the coater must move individual poles, or smaller sub-racks of parts, from one rack to the booth, and subsequently from the booth to another rack. This process is limited either by the size of the parts, the size of the sub-rack, or by the weight of the parts. Using 6″×6″×1″ modem housings as an example, in a 6′×6′×16′ oven, the coater can currently move at most approximately 12 parts at a time and must travel, supporting and maneuvering the weight of 12 parts plus the sub-rack, roughly 30 feet. These sub-racks must be manually hung one at a time, and therefore require extra space in between. Using longer sub-racks, the movement of which is controlled in two dimensions by the tracks, and filling them more densely, the Track Rack system allows the coater to move 84 parts at once, covering roughly half the distance, and the weight is supported by the tracks.

2) Increased Part Density: Currently, different size parts are generally processed on different size racks. Smaller parts are generally processed on smaller racks and larger parts on larger racks. The Track System will accommodate any size part that will fit in the oven, even those that are longer that the oven rack itself. By abutting two oven racks to a booth rack, the powder coating can fully access a part twice as long as the oven rack. Wide parts can be accommodated by utilizing only a portion of the array of tracks. Smaller sub-racks holding smaller parts can be placed on the full array of tracks. A single 7.5′×2.75′×5.75′ oven rack, used with a 6′×6′×16′ oven, can process a full-size car frame or 1,092 6″×6″×1″ modems. As four of this size oven rack can fit in the oven, 4,368 modems could be baked at once, compared to approximately 600 modems using conventional racks. This degree of flexibility is not found in line systems.

3) Reduced maintenance/replacement: The booth rack will become coated with raw powder from overspray, but as it never goes into the oven it can be simply blown off with air. As parts are currently processed in the batch system, racks that are put into the booth are subsequently put into the oven resulting in significant cured powder buildup, reduction in ground and contamination of caster bearings. The oven rack portion of the Track Rack system never enters the booth, and therefore is not subject to overspray and contamination. The replacement or expensive stripping of powder coating racks is eliminated by the Track Rack system.

Therefore, it is an aspect of the invention to provide a material handling system that allows parts to be packed densely on a rack while allowing them to be easily accessible to the person processing them.

It is a further aspect of the invention to provide a material handling system that does not require individual parts to be transferred from one rack or sub-rack to another after initial processing.

It is a further aspect of the invention to provide a material handling system that allows ovens or other batch processing areas or devices to be densely loaded without affecting the efficiency of other stages of the process.

It is a further aspect of the invention to provide a material handling system that does not require a large investment in equipment or installation costs.

It is a still further aspect of the invention to provide a material handling system that combines the flexibility of the batch process with the efficiency of the line process.

These aspects of the invention are not meant to be exclusive and other features, aspects, and advantages of the present invention will be readily apparent to those of ordinary skill in the art when read in conjunction with the following description and accompanying drawings.

### BRIEF DESCRIPTION OF THE DRAWINGS

FIG. 1 is an isometric view of a preferred embodiment of the material handling system of the present invention.

FIG. 2A is an isometric view of a preferred booth rack of the material handling system of the present invention.

FIG. 2B is an exploded partial view of the ends of tracks of the booth rack of FIG. 2A showing alignment tabs and a toggle latch type rack attachment system.

FIG. 2C is an exploded partial view of and end of the top frame of the booth rack of FIG. 2A showing a chain type flexible attachment.

FIG. 3A is an isometric view of a preferred track bar of the rack of the present invention and a partial view of the end of the top frame of the booth rack showing the engagement of the track bar with the track.

FIG. 3B is an exploded partial view of the end of the top frame of the booth rack of FIG. 3A showing the engagement of the track bar with the track.

FIG. 4 is a partial side view of the ends of the tracks of a rack of the present invention showing a track lock type stop mechanism.

FIG. 5 is an end view of the preferred embodiment of the cross member that holds the tracks in place.

### DETAILED DESCRIPTION OF THE INVENTION

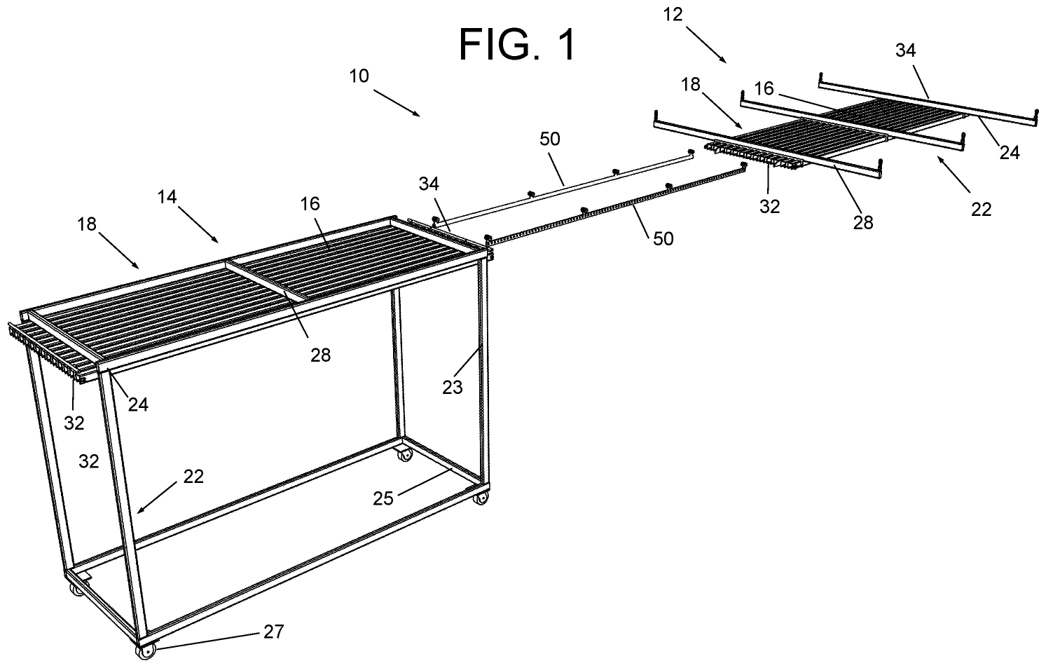

Referring first to FIG. 1, the preferred material handling system 10 utilizes two racks 12, 14, each of which contain rows of tracks 16 arrayed across the top section 18, or “ceiling”, of the racks 12, 14. The first rack 12 is referred to as the “booth rack” and the second rack 14, to which parts are transferred from the booth rack, is called the “oven rack”. The array of tracks 16 on each rack 12, 14 is precisely aligned so that when the oven rack 14 abuts the booth rack 12, slidable track bars 50 onto which parts are attached may be transferred from the booth rack 12 to the oven rack 12. This allows “sheets” of parts to be transferred from one rack to the other on individual tracks.

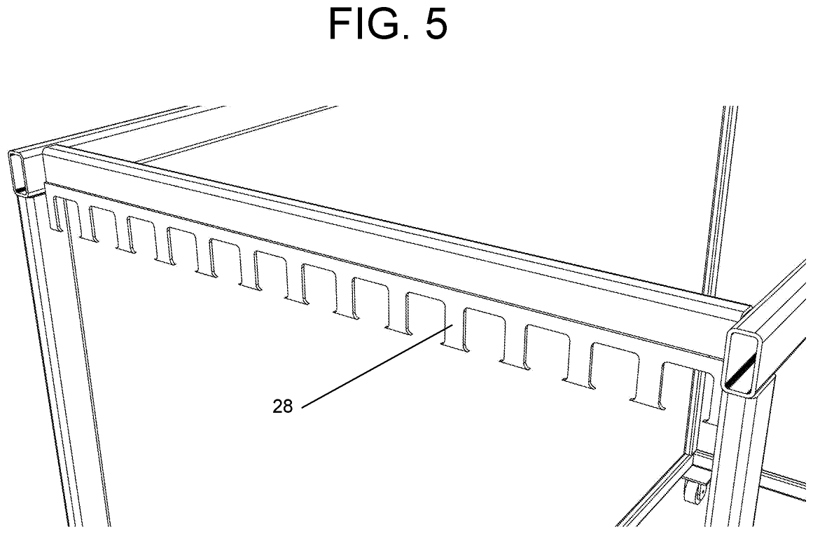

The oven rack 14 of the present invention includes a rack frame 22 having a top section 18 to which a plurality of tracks 16 is disposed. The tracks 16 are disposed in parallel relation to one another and are spaced in a predetermined manner such that the tracks 16 of the oven rack 14 will align with the tracks 16 of the booth rack 12. In the preferred embodiment, the tracks 16 of each rack 12, 14 are spaced by the use of precision formed cross members 28, which align the tracks 16 and provide structural support for the tracks to allow them to be used in heavy duty applications. The preferred embodiment of the cross members 28 is shown in FIG. 5.

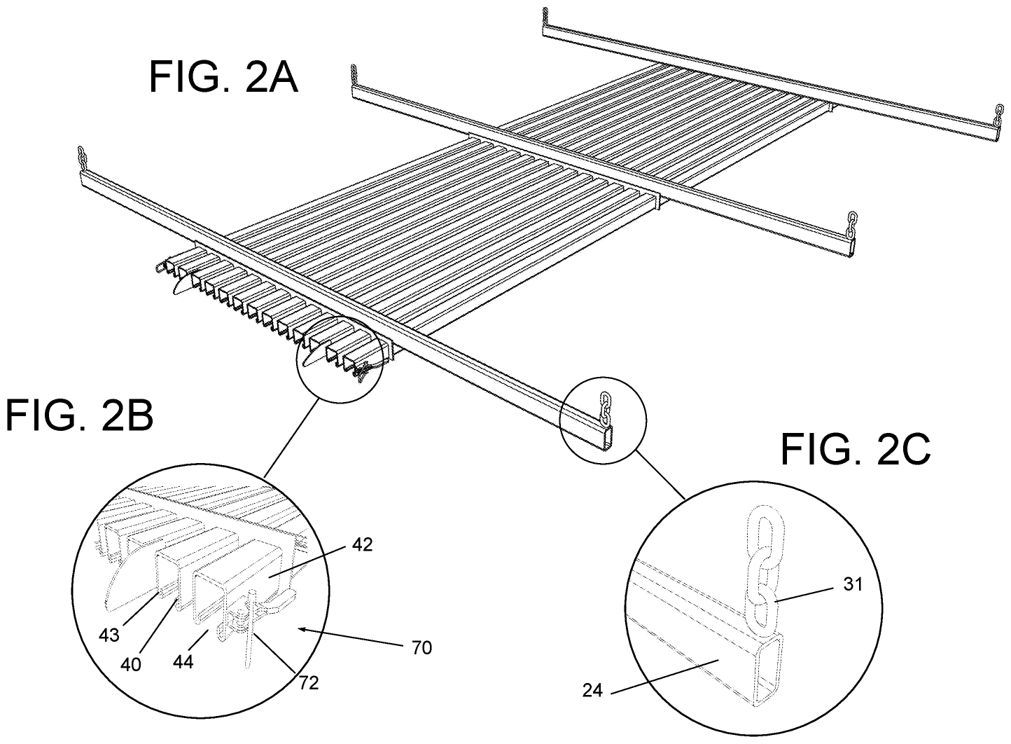

Each track 16 is of substantially uniform cross section and includes a pair of open ends and an open slot through its bottom. As shown in greater detail in FIGS. 2A and 2B, the preferred tracks 16 are formed sheet metal channels having flat portions 40 along the bottom 43 parallel to each side 42 of the open slot 44. However, other tracks may be extruded or formed by other processes known in the art.

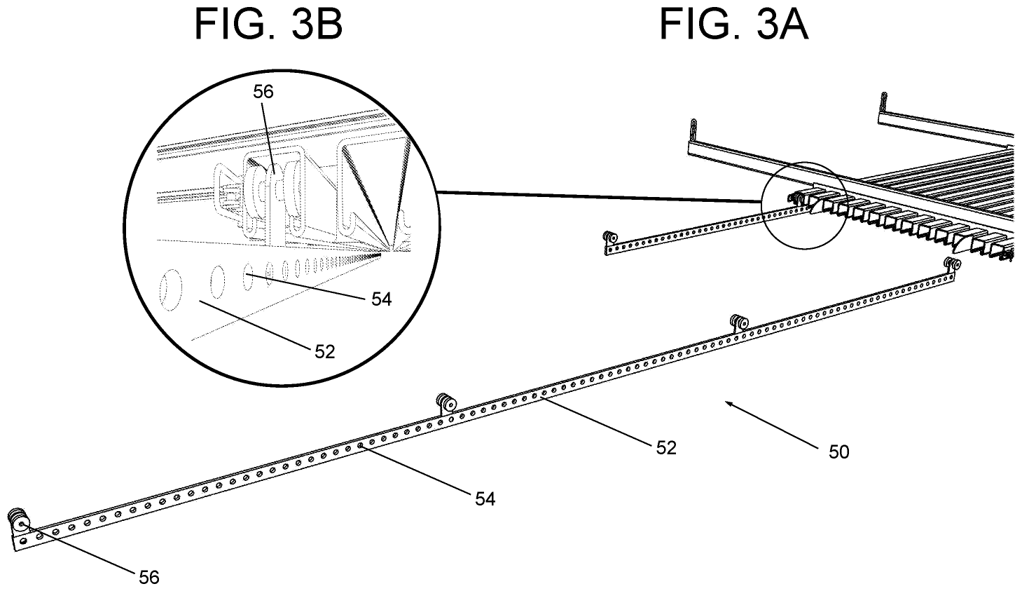

The racks 12, 14 also include at least one track bar 50, and preferably include one track bar 50 for each track. As shown in FIGS. 1, 3A and 3B, the track bar 50 is adapted to fit within the track 16 such that a part racking portion 52 thereof extends below the bottom 43 of the track 16 and such that it may be easily slid in and out of the open ends 32, 34 of the track 16. The part racking portion 52 of the track bar 50 is preferably a rectangular metal bar having a plurality of perforations 54 therethrough to allow parts to be hung from hooks or sub-racks (not shown). The part racking portion 52 is preferably sized to correspond with the size of the track but, in some embodiments, may be shorter or longer. The preferred track bar 50 includes at least two, and preferably four, track casters 56 attached to the top of the part racking portion 52 of the track bar 50. The casters 56 are dimensioned to fit within the track 16 and are attached to the part racking portion 52 such that the part racking portion 52 is suspended below the bottom 43 of the open slot 44 in the track16. The casters 56 allow the track bar 50 to be quickly and easily slid into and out of the open ends 32, 34 of the track 16.

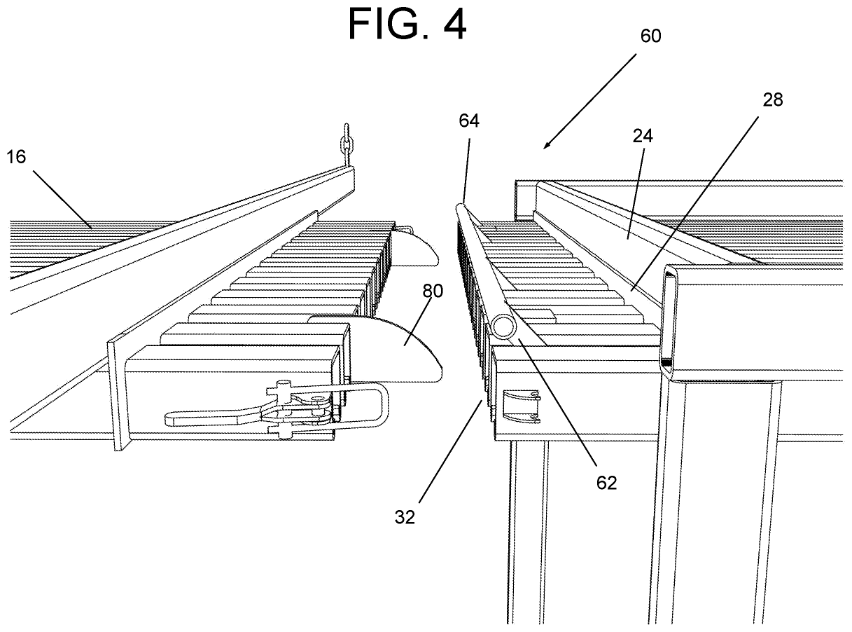

As shown in FIG. 4, the preferred oven rack 14 includes a stop mechanism that allows the track bars 50 to be locked into place, which prevents them from inadvertently sliding out of the tracks when the oven rack 14 is moved. In the preferred embodiment, the stop mechanism is a track lock 60 that creates a barricade at the open end 32 of each track 16. The preferred track lock 60 includes a locking tube 64 that is pivoted upward by a pivot 62 and clears the ends 32 of the tracks 32 by a protrusion 80 extending from an adjacent rack. It is noted that FIG. 4 shows the locking tube 64 in the position that it would be in were the both rack 12 and oven rack 14 joined together with the protrusions 80 holding the locking tube 64 in position. However, when the oven rack 12 is removed from the booth rack 12, the locking tube 64 automatically falls back into place in front of the open ends 32 of the tracks 16 to prevent their movement. In another embodiment, the stop mechanism is a toggle cam style mechanism (not shown), in which a pivoting toggle is manually rotated to engage a series of cams that extend through slots in each track and exert a downward force upon each track bar to maintain it in place.

Referring again to FIG. 1, the rack frame 22 of the oven rack 14 is preferably manufactured of metal and takes the form of an open sided rectangular parallelepiped having four side members 23, four top members 22 and four bottom members 25. In the preferred embodiment, four casters 27 extend from the bottom four members 25 of the rack frame 22 to allow it to be easily moved from one location to another. However, these casters 27 are omitted in other embodiments and, instead, the racks are moved by external means, such as carts or rails.

In some embodiments, the oven rack 14 and the booth rack 12 are substantially identical. However, in the embodiment of FIGS. 1 and 2A-2C, the rack frame 22 of the booth rack 12 is made up only of a series of top members 28 to which the tracks are disposed. As shown in FIG. 2C, in these embodiments, the top members 28 preferably include flexible attachments 31, such as chains, cables or the like, that suspend the rack from a ceiling and allow it to be more easily aligned with an adjacent rack.

As shown in FIG. 2C, the preferred rack also includes a rack attachment system that allows one rack to be attached to another. The preferred rack attachment system is a toggle latch system 70 in which toggle latches 72 are mounted to each side of one rack and slide into mating latches on an adjacent rack. However, in other embodiments the rack attachment system may simply take the form of a pin or magnetic latch that affixes the racks in the desired position.

Although the present invention has been described in considerable detail with reference to certain preferred versions thereof, other versions would be readily apparent to those of ordinary skill in the art. Therefore, the spirit and scope of the appended claims should not be limited to the description of the preferred versions contained herein.

What is claimed is:

1. A material handling rack comprising:
a rack frame comprising a top section to which a plurality of tracks is disposed:
wherein said plurality of tracks are disposed in parallel relation to one another;
wherein said plurality of tracks are spaced such that said tracks of one of said rack frames align with said tracks of another of said rack frames;
wherein each of said plurality of tracks is of substantially uniform cross section; and
wherein each of said plurality of tracks comprises a pair of open ends, a bottom, an open slot through said bottom, and two open slot sides on either side of said open slot; and
at least one track bar comprising:
a part racking portion comprising a top, wherein said at least one track bar is adapted to fit within one of said tracks such that said part racking portion extends below said bottom of said track and such that said track bar easily slides in and out of said open ends of said track; and
at least two track casters dimensioned to fit within one of said tracks and attached to said top of said part racking portion such that said part racking portion is suspended below said bottom of said track.

2. The material handling rack as claimed in claim 1, wherein said tracks are spaced by precision formed cross members.

3. The material handling rack as claimed in claim 1, wherein said tracks are formed of sheet metal channels comprising flat portions along said bottoms of said tracks, wherein said flat portions are parallel to each of said open slot sides of said open slot.

4. The material handling rack as claimed in claim 1, wherein said material handling rack comprises an equal number of said track bars and said tracks.

5. The material handling rack as claimed in claim 1, wherein said part racking portion of said track bar is a rectangular metal bar sized to correspond to a size of said tracks, and said part racking portion comprises a plurality of perforations extending through said rectangular metal bar.

6. The material handling rack as claimed in claim 1, wherein said at least two track casters are four track casters.

7. The material handling rack as claimed in claim 1, further comprising at least one stop mechanism that allows said track bars to be locked into place.

8. The material handling rack as claimed in claim 7, wherein said at least one stop mechanism is at least one track lock that creates a barricade at said open end of each of said tracks.

9. The material handling rack as claimed in claim 8, further comprising a protrusion, wherein said at least one track lock comprises a locking tube, and wherein said locking tube is pivotable upward to clear said open ends of said tracks by said protrusion of adjacent material handling racks.

10. The material handling rack as claimed in claim 7, wherein said at least one stop mechanism is at least one toggle cam style mechanism comprising a pivoting toggle, wherein said tracks further comprise a series of cams extending through slots in said tracks, and wherein said pivoting toggle is manually rotatable to engage said series of cams.

11. The material handling rack as claimed in claim 1, wherein said rack frame is manufactured of metal and is formed as an open sided rectangular parallelepiped comprising four side members, four top members, and four bottom members.

12. The material handling rack as claimed in claim 11, wherein four casters extend from each of said four bottom members of said rack frame.

13. The material handling rack as claimed in claim 1, wherein said rack frame is manufactured of metal and comprises at least two top members.

14. The material handling rack as claimed in claim 13, wherein said at least two top members comprise flexible attachments.

15. The material handling rack as claimed in claim 1, further comprising a rack attachment system that allows one of said material handling racks to be attached to another of said material handling racks.

16. The material handling rack as claimed in claim 15, wherein said material handling rack comprises two sides, and wherein said rack attachment system is a toggle latch system comprising toggle latches mounted to each of said two sides of said material handling rack and sized and dimensioned to slide into said toggle latches on an adjacent material handling rack.

17. A material handling system for handling parts, comprising slidable track bars onto which said parts are attached, a booth rack, and an oven rack:
wherein each of said booth rack and said oven rack comprises a top section and an array of tracks arrayed across said top section; and
wherein said arrays of tracks of said booth rack and said oven rack are aligned such that when said oven rack abuts said booth rack, said slidable track bars are transferrable from said booth rack to said oven rack.

18. The material handling system as claimed in claim 17, wherein said booth rack and said oven rack are identical racks.

19. The material handling system as claimed in claim 17 further comprising an oven and said oven rack is dimensioned to fit in said oven and is removable from and replaceable to said oven.

20. A method for processing parts comprising the following steps:
aligning two racks together such the tracks of one rack correspond to the tracks of the other;
processing parts mounted to a first track bar disposed in a first track of the first rack;
sliding the first track bar from the first rack to the second rack;
processing parts mounted to a second track bar disposed in a second track of the first rack;
sliding the second track bar from the first rack to the second rack;
continuing to process parts mounted to track bars disposed in tracks of the first rack;
continuing to slide the track bars from the first rack to the second rack until the second rack is full;
moving the second rack into a batch processing station for batch processing; and
removing the second rack from the batch processing station after the parts have been processed.
